(19) United States
(12) Patent Application Publication
(10) Pub. No.: US 2011/0083911 A1
(43) Pub. Date: Apr. 14, 2011

(54) Capacitive Touch Sensing Apparatus and Detection Method Thereof

(76) Inventors: Chih-Hsin Hsu, Hsinchu City (TW); Wing-Kai Tang, Hsinchu City (TW)

(21) Appl. No.: 12/777,271

(22) Filed: May 11, 2010

(30) Foreign Application Priority Data
Oct. 14, 2009 (TW) 098134752

(51) Int. Cl. G06F 3/044

(52) U.S. Cl. 178/18.06

(57) ABSTRACT

A capacitive touch sensing apparatus includes a plurality of sensing capacitor units, a control signal generation unit, a plurality of high impedance controllers, and a detection unit. The plurality of sensing capacitor units are utilized for generating a plurality of touch analog signals. The control signal generation unit is utilized for generating a plurality of control signals. The plurality of high impedance controllers are installed by intersections of a plurality of control signal lines and a plurality of signal transmission lines, where each of the high impedance controllers conducts a corresponding touch analog signal to a corresponding signal transmission line according to a corresponding control signal. The detection unit is utilized for determining whether a touch event occurs according to the conducted touch analog signal

### BACKGROUND OF THE INVENTION

1. Field of the Invention

The present invention relates to a capacitive touch sensing apparatus and related detection method, and more particularly, to a capacitive touch sensing apparatus capable of application to multi-touch detection and related detection method.

2. Description of the Prior Art

Touch panels are utilized widely in various consumer electronic products, such as personal digital assistants, smart mobile phones, notebooks, and point of sale systems (POS), etc., and offer advantages of convenient operation, rapid response speed, and economic use of space. Capacitive touch techniques exhibit stable performance, excellent sensitivity and durability, making them some of the most popular touch techniques.

In general, the capacitive touch technique utilizes capacitive variations from static electricity generated by touch between the human body and the touch panel to determine a touch event. In other words, according to the difference of capacitance characteristic after touching the touch point to realize touch functions. Please refer to FIG. 1. FIG. 1 is a schematic diagram of a capacitive touch sensing apparatus 10 according to the prior art. The capacitive touch sensing apparatus 10 includes sensing capacitor chains X₁ to Xₘ and Y₁ to Yₙ. Each sensing capacitor chain forms a one-dimensional structure of multiple series-connected sensing capacitors. The conventional touch detection method detects the capacitance of each sensing capacitor chain to determine whether a touch event occurs. Supposing the sensing capacitor chain X₁ includes Q sensing capacitors, and the capacitance value of each sensing capacitor is C, the capacitance value of each sensing capacitor chain is equal to QC. When the human body (ex. finger) touches a certain sensing capacitor of the sensing capacitor chain, the amount of capacitance variation of the sensing capacitor chain X₁ is ΔC. In such a condition, as the detected capacitance value of the sensing capacitor chains X₁ is (QC+ΔC), this means the finger is touching a certain place of the sensing capacitor chains X₁ at this time. As shown in FIG. 1, when the finger touches on the touch point A (i.e. at coordinates (X₃, Y₃)), both the sensing capacitor chains X₃ and Y₃ are able to sense the capacitance variation simultaneously so that capacitive touch sensing apparatus 10 determines that a touch sensing point is at (X₃, Y₃).

However, in a multi-touch situation, a determination error may occur. For example, please refer to FIG. 2, which is a schematic diagram of the capacitive touch sensing apparatus 10 during multi-touch operation according to the prior art. As shown in FIG. 2, two fingers respectively touch the capacitive touch sensing apparatus 10 at the same time. In this condition, the sensing capacitor chains X₃, Xₘ₋₁, Y₃, and Yₙ₋₁ are all able to sense the capacitance variation simultaneously so that capacitive touch sensing apparatus 10 will determine that the touch events are occurring at (X₃, Y₃), (X₃, Yₙ₋₁), (Xₘ₋₁, Y₃), and (Xₘ₋₁, Yₙ₋₁). But, in fact, only the points at (X₃, Y₃) and (Xₘ₋₁/Yₙ₋₁) are real touch points, whereas the points at (X₃, Yₙ₋₁) and (Xₘ₋₁, Y₃) are actually not real touch points. Therefore, the capacitive touch sensing apparatus 10 incorrectly determines that the non-real touch points (X3, Yₙ₋₁) and (Xₘ₋₁, Y₃) are real touch points. This type of error is also called a “ghost key”. In short, the prior art is only able to provide information indicating at which crossing section of the sensing capacitor chains a touch event may be occurring for the multi-touch situation, but cannot accurately locate the real touch points.

In addition, for realizing two-dimensional operation, two processes are required for the capacitive touch sensing apparatus 10 to form two layers of transparent electrodes for manufacturing the sensing capacitor chains X₁ to Xₘ and Y₁ to Yn. However, using two processes may increase production cost significantly. On the other hand, the structure of the capacitive touch sensing apparatus 10 used for sensing detection should be concerned with the sum of capacitances of all the sensing capacitors for each sensing capacitor chain. In such a condition, the ratio of the capacitance variation generated by touch to the sum of capacitances of all the sensing capacitors may be too low. In other words, capacitive touch sensing apparatus 10 may have poor sensing sensitivity (ΔC/(QC+ΔC)) making it likely that an error will occur when detecting capacitance variation. Therefore, as more sensing capacitors are included in the sensing capacitor chain, the sensitivity may decrease.

### SUMMARY OF THE INVENTION

It is therefore an objective of the present invention to provide a capacitive touch sensing apparatus and detection method thereof.

The present invention discloses a capacitive touch sensing apparatus which includes a substrate, a plurality of sensing capacitor units, a plurality of control signal lines, a control signal generation unit, a plurality of high impedance controllers, and a detection unit. The plurality of sensing capacitor units is disposed on the substrate for generating a plurality of analog touch signals. The plurality of control signal lines is parallel with each other and disposed along a first direction. The plurality of signal transmission lines is parallel with each other and disposed along a second direction different from the first direction. The control signal generation unit is coupled to the plurality of control signal lines for generating a plurality of control signals transmitted through the plurality of control signal lines. The plurality of high impedance controllers, respectively disposed by intersections of the plurality of control signal lines and the plurality of signal transmission lines, wherein each of the high impedance controllers comprises an input end coupled to a corresponding sensing capacitor unit, a control end coupled to a corresponding control signal line, and an output end coupled to a corresponding signal transmission line, for conducting a corresponding analog touch signal generated by the corresponding sensing capacitor unit to the corresponding signal transmission line according to the corresponding control signal. The detection unit is coupled to the plurality of signal transmission lines for determining sensing variations of the plurality of sensing capacitor units according to the plurality of analog touch signals to detect whether a touch event occurs on the corresponding sensing capacitor unit.

The present invention further discloses a capacitive touch sensing apparatus which includes a substrate; a sensing capacitor unit, disposed on the substrate, for generating an analog touch signal; a control signal generation unit, for generating a control signal; a detection unit, for determining sensing variations of the sensing capacitor unit according to the analog touch signal to detect a touch event; and a high impedance controller, coupled to the sensing capacitor unit, the control signal generation unit, and the detection unit, for conducting the analog touch signal to the detection unit according to the control signal.

The present invention further discloses a multi-touch detection method for a capacitive touch sensing apparatus, the capacitive touch sensing apparatus including a plurality of control signal lines, a plurality of signal transmission lines, a plurality of high impedance controllers, the plurality of control signal lines parallel with each other and disposed along a first direction, the plurality of signal transmission lines parallel with each other and disposed along a second direction different from the first direction, the plurality of high impedance controllers respectively disposed by intersections of the plurality of control signal lines and the plurality of signal transmission lines, the multi-touch detection method including generating a plurality of analog touch signals; generating a plurality of control signals transmitted through the plurality of control signal lines; conducting a corresponding analog touch signal to a corresponding signal transmission line according to a corresponding control signal by each of the corresponding high impedance controller; and determining whether sensing variation occurs according to the conducted analog touch signal to detect a touch event.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a capacitive touch sensing apparatus according to the prior art.

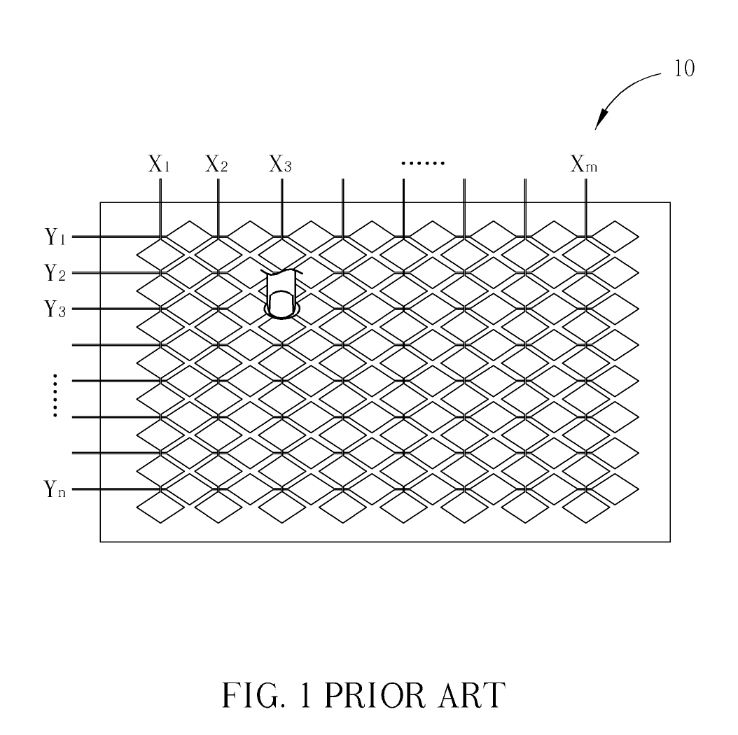

FIG. 2 is a schematic diagram of the capacitive touch sensing apparatus during multi-touch operation according to the prior art.

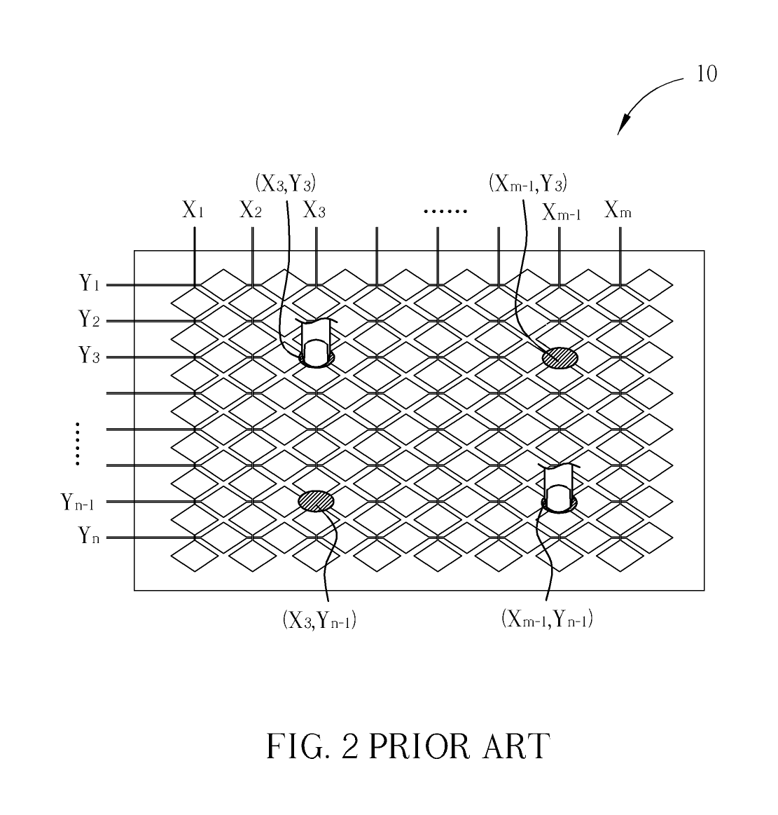

FIG. 3 is a schematic diagram of a capacitive touch sensing apparatus according to a first embodiment of the present invention.

FIG. 4 is a schematic diagram of a capacitive touch sensing apparatus according to second embodiment of the present invention.

FIG. 5 is a schematic diagram of a detection procedure 50 for implementation the capacitive touch sensing apparatus 30 shown in FIG. 3 according to an embodiment of the invention.

FIG. 6 is a schematic diagram of the capacitive touch sensing apparatus shown in FIG. 3 with multi-touch according to an embodiment of the present invention.

FIG. 7 is a schematic diagram of signal waveforms of the capacitive touch sensing apparatus shown in FIG. 3 with multi-touch according to an embodiment of the present invention.

### DETAILED DESCRIPTION

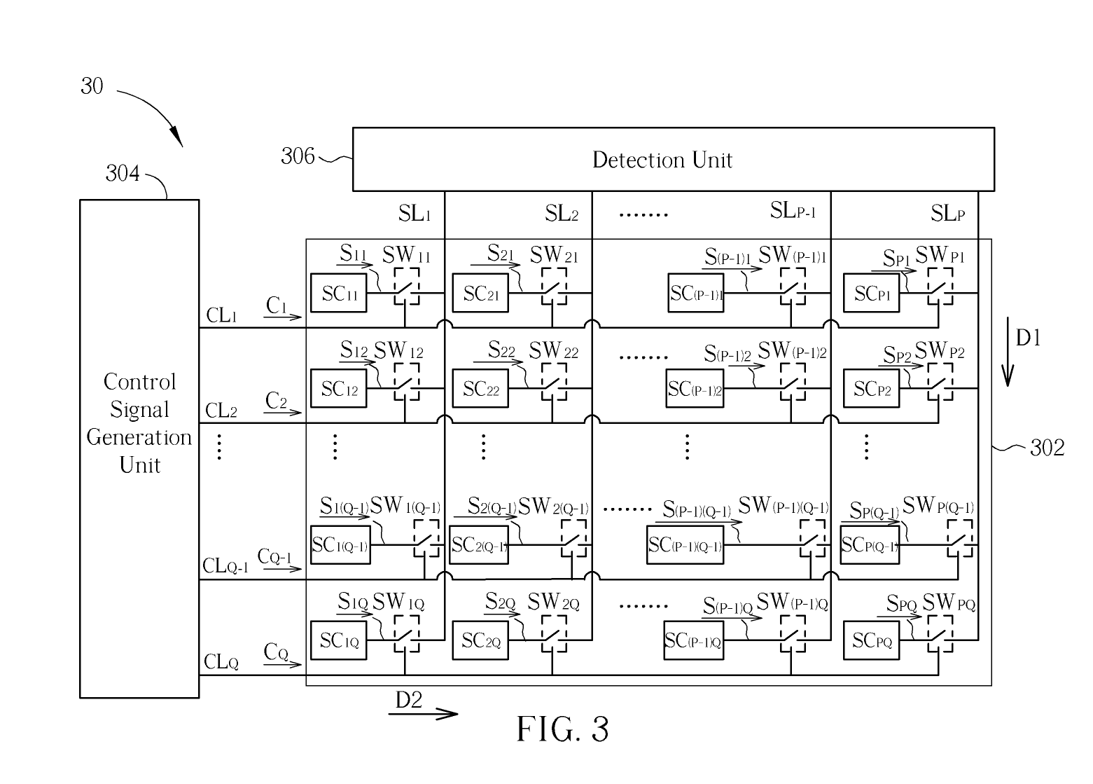

Please refer to FIG. 3. FIG. 3 is a schematic diagram of a capacitive touch sensing apparatus 30 according to an embodiment of the present invention. The capacitive touch sensing apparatus 30 includes a substrate 302, sensing capacitor units SC₁₁ to SC_{PQ}, control signal lines CL₁ to CL_{Q}, signal transmission lines SL₁ to SL_{P}, a control signal generation unit 304, high impedance controllers SW₁₁ to SW_{PQ}, and a detection unit 306. The sensing capacitor units SC₁₁ to SC_{PQ} are disposed on the substrate 302 for generating analog touch signals S₁₁ to S_{PQ} respectively. Each of the analog touch signals is capable of including an environmental capacitance CAP_{E} and a variation amount CAP_{V} of touch sensing capacitance of the corresponding sensing capacitor unit. Note that the variation amount CAP_{V} of touch sensing capacitance of the corresponding sensing capacitor unit changes when a human body touches the corresponding sensing capacitor unit. As shown in FIG. 3, the control signal lines CL₁ to CL_{Q} can be disposed along a first direction D1 and put in parallel with each other. The signal transmission lines SL₁ to SL_{P} can be disposed along a second direction D2 and put in parallel with each other. The control signal generation unit 304 is coupled to the control signal lines CL₁ to CL_{Q} for generating control signals C₁ to C_{Q}, and each of the control signal lines CL₁ to CL_{Q} can be utilized for transmitting the corresponding control signal. The high impedance controllers SW₁₁ to SW_{PQ} are respectively disposed by intersections of the control signal lines CL₁ to CL_{Q} and the signal transmission lines SL₁ to SL_{P}, and each of the high impedance controllers SW₁₁ to SW_{PQ} includes an input end coupled to a corresponding sensing capacitor unit, a control end coupled to a corresponding control signal line, and an output end coupled to a corresponding signal transmission line. For example, the high impedance controller SW₁₂ is disposed between the signal transmission line SL₁ and the control signal line CL₂. The input end of the high impedance controller SW₁₂ is coupled to the sensing capacitor unit SC₁₂, the control end of the high impedance controller SW₁₂ is coupled to the control signal line CL₂, and the output end of the high impedance controller SW₁₂ is coupled to the signal transmission line SL₁. This way, each high impedance controller can conduct the connection between the input end and the output end to transmit the analog touch signal generated by the corresponding sensing capacitor unit to the corresponding signal transmission line according to the corresponding control signal received by the control end.

Furthermore, the detection unit 306 is coupled to the signal transmission lines SL₁ to SL_{P} for determining sensing variations of the sensing capacitor units SC₁₁ to SC_{PQ} to detect whether a touch event occurs on the corresponding sensing capacitor unit. Note that, through the control operation of the control signal generation unit 304, only one of the control signals C₁ to C_{Q} is in an enable state EN at a time, and the other control signals are in a disable state DN. In other words, at the same time, only one control signal transmitted on the corresponding control signal line is in the enable state EN, so that only the high impedance controller connected to the corresponding control signal line is able to be enabled and conducted to forward the corresponding analog touch signal to the corresponding signal transmission line accordingly. The corresponding analog touch signal can be transmitted to the detection unit 306 via the corresponding signal transmission line for touch event determination. Therefore, through the timing arrangement of the control signal generation unit 304, the control signals C₁ to C_{Q} can be switched in turn to the enable state, so that a certain high impedance controller coupled to the corresponding control signal line is enabled at the same time. This means the detection unit 306 is capable of receiving at most one analog touch signal from the signal transmission lines SL₁ to SL_{P} at the same time. For example, the control signal generation unit 304 can control the control signals C₁ to C_{Q} of the control signal lines CL₁ to CL_{Q} to be switched to the enable state along the first direction D1 by turns, i.e. the control signal generation unit 304 can control the control signals C₁ to C_{Q} corresponding to control signal lines CL₁ to CL_{Q} to be switched to the enable state from the control signal C₁ to the control signal C_{Q} in order. In other words, after all the control signals C₁ to C_{Q} have switched to the enable state once, a scan detection for the sensing capacitor units SC₁₁ to SC_{PQ} is performed. As a result, the present invention can exactly detect the touch situation of every sensing capacitor unit to achieve accurate location.

Please note, although in the above disclosure, the present invention enables the control signal one by one (enable only one control signal in a specific time point), this is only regarded as an embodiment, not a limitation of the present invention. In the actual implementation, the present invention can enable more than one control signal at the same time. For example, the present invention can enable two control signals corresponding to successive rows to detect the touch situation. Or, the present invention can enable more control signals to detect a rough touch situation, and if the ghost key phenomenon occurs, the present invention can enable the control signal corresponding to the touch position to perform a more detailed touch situation (to determine whether the touch position is a real touch or a ghost key). These changes also obey the spirit of the present invention.

In short, the prior art is not able to detect the real touch event exactly for multi-touch situations and also needs to estimate the sum of capacitance of all sensing capacitors for each sensing capacitor chain. Comparatively, the present invention can analyze the analog touch signal of the sensing capacitor unit corresponding to each control signal line to detect the touch situation of each sensing capacitor unit so as to realize accurate multi-touch location. In addition, the present invention can accomplish the touch detection by only estimating the relative physical characteristics of single sensing capacitors. Accordingly, the poor sensitivity of touch detection in the prior art can be improved upon substantially. In other words, by using the control signals and switches, the present invention can detect the touch situation more actively. Unlike the prior art passive touch sensing mechanism, the present invention can actively avoid the ghost key phenomenon or determine whether a sensed touch position is a ghost key or not.

Preferably, in the embodiment of the present invention, after the detection unit 306 receives the transmitted analog touch signal via the signal transmission lines SL₁ to SL_{P}, the detection unit 306 can determine whether the sum of the environmental capacitance CAP_{E} and the variation amount CAP_{V} of touch sensing capacitance included in the transmitted analog touch signal is greater than a first threshold value TH1 or not. If yes, the detection unit 306 determines the sensing capacitor units undergo a touch event. Optionally, the detection unit 306 can determine whether the variation amount CAP_{V} of touch sensing capacitance included in the transmitted analog touch signal is greater than a second threshold value TH2 or not. If yes, the detection unit 306 determines the sensing capacitor units undergoes a touch event. The second threshold value TH2 is equal to the sum of the environmental capacitance CAP_{E} and the second threshold value TH1.

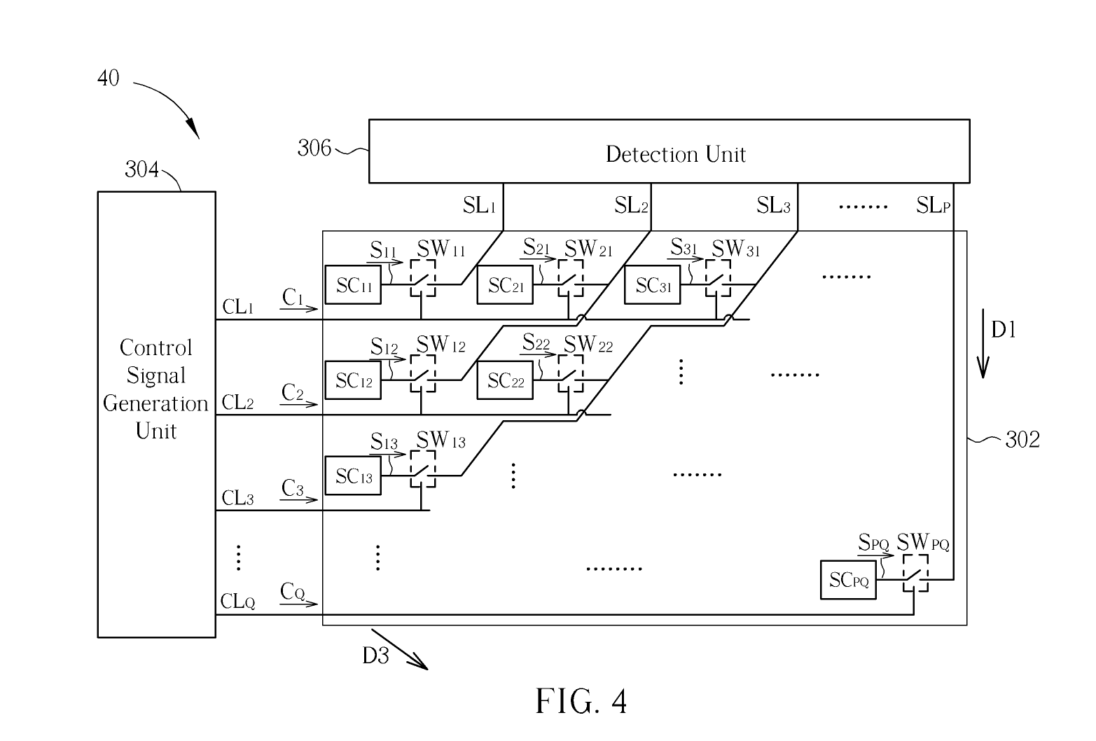

On the other hand, the control signal lines CL₁ to CL_{Q} and the signal transmission lines SL₁ to SL_{P} are utilized for signal transmission. The intersections of the control signal lines and the signal transmission lines represent their relative positions. In practice, no connection or touch relationship exists between the control signal lines and the signal transmission lines. Moreover, each control signal line is utilized for applying to the same control signal to all of the high impedance controllers coupled thereto for conducting the analog touch signals of the corresponding sensing capacitor units. The control signal lines CL₁ to CL_{Q} can be arranged in any manner. Preferably, the control signal lines CL₁ to CL_{Q} can be arranged in parallel with each other for achieving the optimal detection efficiency. In addition, regarding the relationship among all the control signal lines and all the signal transmission lines, each control signal line and each signal transmission line is not capable of overlapping each another. For example, as shown in FIG. 3, all the control signal lines can be arranged to be perpendicular to the signal transmission lines, or, as shown in FIG. 4, the signal transmission lines SL₁ to SL_{P} which are parallel with each other are arranged along the third direction D3, which should not be a limitation of the present invention.

Note that the embodiment of the capacitive touch sensing apparatus 30 represents exemplary embodiments of the present invention, and those skilled in the art can make alternations and modifications accordingly. For example, the amount and arrangement of the sensing capacitor units of the capacitive touch sensing apparatus 30 are exemplary embodiments of the present invention, and should be not limited to the present invention, such as being only one sensing capacitor unit or depending on system design. In addition, the sensing capacitor unit can take any shape and area, and the sensing capacitor unit can be any device having capacitive variation while being touched by a human body or conducting object. For example, the sensing capacitor unit can be an electrode. The electrode can be made of an indium tin oxide (ITO) material, or other transparent electrode materials. In addition, any devices which can select to output the corresponding analog touch signal according to the corresponding control signal are suitable for implementing the high impedance controller. For example, a switch element can be utilized for implementing the high impedance controller. The switch element can be implemented by any type of metal-oxide-semiconductor (MOS), thin-film transistor, low temperature poly silicon thin-film transistor, or combination thereof.

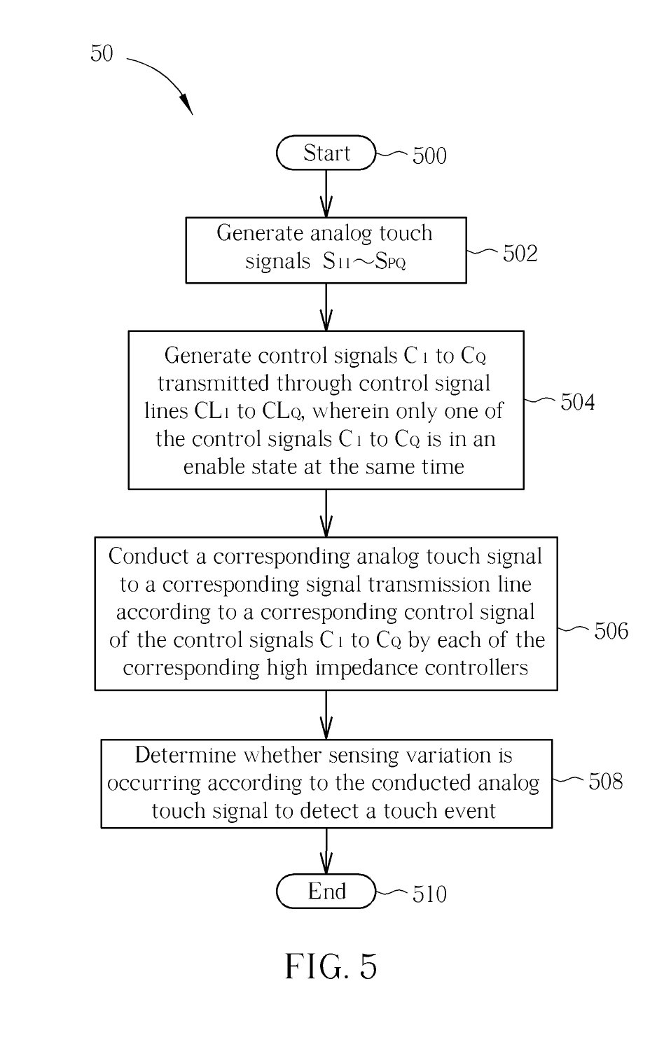

As to operation of the capacitive touch sensing apparatus 30, please refer to FIG. 5. FIG. 5 is a schematic diagram of a detection procedure 50 for implementation in the capacitive touch sensing apparatus 30 shown in FIG. 3 according to an embodiment of the invention. The detection procedure 50 comprises the following steps:

Step 500: Start.

Step 502: Generate analog touch signals S₁₁ to S_{PQ}.

Step 504: Generate control signals C₁ to C_{Q} transmitted through control signal lines CL₁ to CL_{Q}, wherein only one of the control signals C₁ to C_{Q} is in an enable state at the same time;

Step 506: Conduct a corresponding analog touch signal to a corresponding signal transmission line according to a corresponding control signal of the control signals C₁ to C_{Q} by each of the corresponding high impedance controllers; and

Step 508: Determine whether sensing variation occurs according to the conducted analog touch signal to detect a touch event.

Step 510: End.

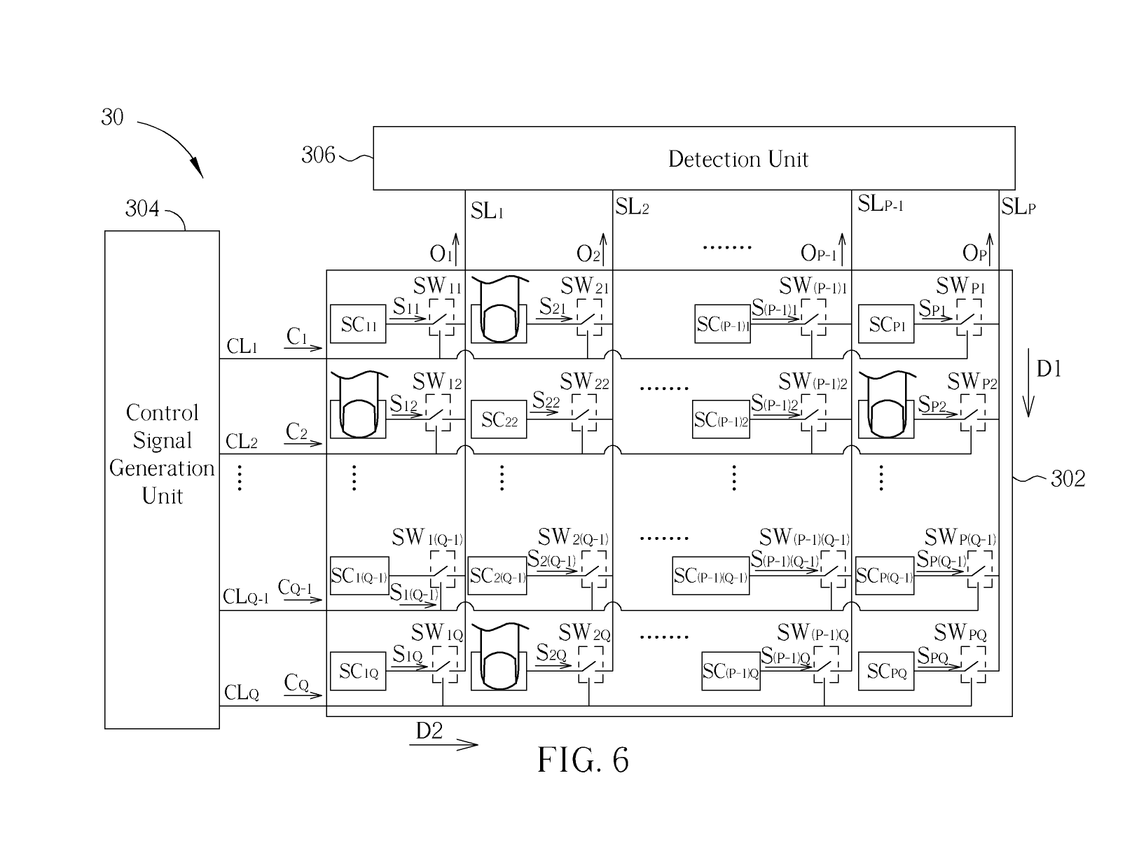

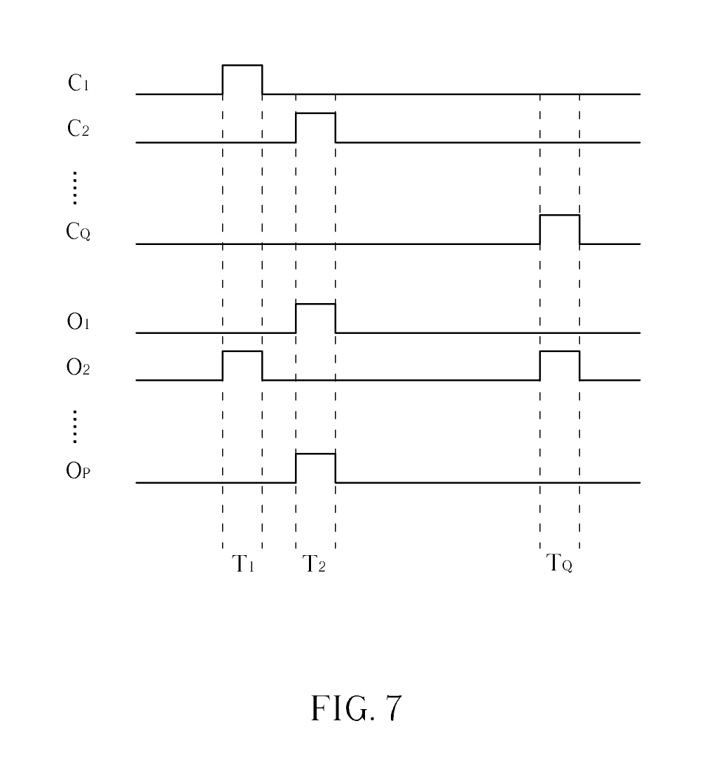

The following further elaborates the operation of the present invention. Taking a four-point multi-touch as an example, i.e. the capacitive touch sensing apparatus 30 is simultaneously touched by four fingers (other human body parts or objects are also acceptable variations). Please refer to FIG. 6 and FIG. 7. FIG. 6 is a schematic diagram of the capacitive touch sensing apparatus 30 shown in FIG. 3 with multi-touch according to an embodiment of the present invention. FIG. 7 is a signal waveform diagram of the capacitive touch sensing apparatus 30 shown in FIG. 3 with multi-touch according to an embodiment of the present invention. First, the capacitive touch sensing apparatus 30 utilizes the sensing capacitor units SC₁₁ to SC_{PQ} for generating the analog touch signals S₁₁ to S_{PQ}. Furthermore, referring to the waveform shown in FIG. 7, the control signal generation unit 304 controls the control signals C₁ to C_{Q} corresponding to control signal lines CL₁ to CL_{Q} to be switched from the control signal C₁ to the control signal C_{Q} by turns. For example, during the time duration T₁, the control signal C₁ is switched to the enable state. The high impedance controllers SW₁₁ to SW_{P1} coupled to the control signal line CL₁ are able to be enabled according to the control signal C₁, and respectively forward the analog touch signals S₁₁ to S_{P1} to the signal transmission lines SL₁ to SL_{P}. After that, the analog touch signals S₁₁ to S_{P1} can be transmitted to the detection unit 306 via the signal transmission lines SL₁ to SL_{P}. In such a condition, the output signals O₁ to O_{P} are respectively equal to the analog touch signals S₁₁ to S_{P1} at this time. In other words, during the time duration T₁, each of the signal transmission lines SL₁ to SL_{P} has merely one analog touch signal, so that the detection unit 306 is capable of detecting whether the sensing capacitor units SC₁₁ to SC_{P1} corresponding to the control signal line CL₁ undergo sensing variation for determining the touch event. Therefore, with the enable timing of the control signals C₁ to C_{Q}, the capacitive touch sensing apparatus 30 can detect the touch situations of all the sensing capacitor units row-by-row successively. In detail, the detection unit 306 detects the sensing capacitor unit SC₂₁ having sensing variation so as to determine the touch event occurs on the sensing capacitor unit SC₂₁ during the time duration T₁. This way, the detection unit 306 detects the sensing capacitor units SC₁₂ and SC_{P2} having sensing variations so as to determining the touch events occur on the sensing capacitor units SC₁₂ and SC_{P2} during the time duration T₂. Finally, the detection unit 306 detects the sensing capacitor unit SC_{2Q} having sensing variation so as to determine the touch event occurs on the sensing capacitor unit SC_{2Q} during the time duration T_{Q}. As a result, the detection unit 306 can accurately determine the touch events occur on the sensing capacitor units SC₂₁, SC₁₂, SC_{P2}, and SC_{2Q} after the control signals C₁ to C_{Q} are switched to the enable state in turn by the control signal C₁ to the control signal C_{Q}. Therefore, the capacitive touch sensing apparatus 30 can conduct the corresponding high impedance controller according to control signal lines CL₁ to CL_{Q} at different times for detecting the touch situation of each sensing capacitor unit exactly.

As mentioned previously, one-by-one enabling the control signal is only regarded as an embodiment of the present invention. In the actual implementation, the present invention can enable multiple control signals at the same time.

In summary, compared with the prior art, the present invention needs not consume manufacturing cost in forming two layers of sensing capacitor electrodes with two processes for the two-dimensional location. In addition, the present invention can accomplish touch detection by only estimating the relative physical characteristics of a single sensing capacitor, enhancing sensitivity of touch detection substantially, and more particularly, the present invention can analyze the analog touch signals of the sensing capacitor units corresponding to each control signal line one-by-one with time to detect the touch situation of each sensing capacitor unit so as to realize accurate multi-location.

Those skilled in the art will readily observe that numerous modifications and alterations of the device and method may be made while retaining the teachings of the invention.

What is claimed is:

1. A capacitive touch sensing apparatus, comprising:
a substrate;
a plurality of sensing capacitor units, disposed on the substrate, for generating a plurality of analog touch signals;
a plurality of control signal lines, parallel with each other and disposed along a first direction;
a plurality of signal transmission lines, parallel with each other and disposed along a second direction different from the first direction;
a control signal generation unit, coupled to the plurality of control signal lines, for generating a plurality of control signals transmitted through the plurality of control signal lines;
a plurality of high impedance controllers, respectively disposed by intersections of the plurality of control signal lines and the plurality of signal transmission lines, wherein each of the high impedance controllers comprises an input end coupled to a corresponding sensing capacitor unit, a control end coupled to a corresponding control signal line, and an output end coupled to a corresponding signal transmission line, for conducting a corresponding analog touch signal generated by the corresponding sensing capacitor unit to the corresponding signal transmission line according to the corresponding control signal; and
a detection unit, coupled to the plurality of signal transmission lines, for determining sensing variations of the plurality of sensing capacitor units according to the plurality of analog touch signals to detect whether a touch event occurs on the corresponding sensing capacitor unit.

2. The capacitive touch sensing apparatus of claim 1, wherein each of the sensing capacitor units comprises an electrode.

3. The capacitive touch sensing apparatus of claim 2, wherein the electrode is made of Indium Tin Oxide material.

4. The capacitive touch sensing apparatus of claim 1, wherein the first direction is perpendicular to the second direction.

5. The capacitive touch sensing apparatus of claim 1, wherein the control signal generation unit controls the plurality of control signals to take turns in the enable state to enable the corresponding high impedance controller coupled to the corresponding control signal line.

6. The capacitive touch sensing apparatus of claim 5, wherein the control signal generation unit controls the plurality of control signals to be in the enable state along the first direction by turns to enable the corresponding high impedance controller coupled to the corresponding control signal line.

7. The capacitive touch sensing apparatus of claim 1, wherein each of the analog touch signals comprises an environmental capacitance and a variation amount of touch sensing capacitance.

8. The capacitive touch sensing apparatus of claim 7, wherein the detection unit determines a sensing capacitor unit corresponding to one of the plurality of analog touch signals undergoing a touch event when the sum of the environmental capacitance and the variation amount of touch sensing capacitance of the corresponding analog touch signal is greater than a threshold value.

9. The capacitive touch sensing apparatus of claim 7, wherein the detection unit determines a sensing capacitor unit corresponding to one of the plurality of analog touch signal undergoing a touch event when the variation amount of touch sensing capacitance of the corresponding analog touch signal is greater than a threshold value.

10. The capacitive touch sensing apparatus of claim 1, wherein only one of the control signals is in an enable state at the same time.

11. A capacitive touch sensing apparatus, comprising:
a substrate;
a sensing capacitor unit, disposed on the substrate, for generating an analog touch signal;
a control signal generation unit, for generating a control signals;
a detection unit, for determining sensing variations of the sensing capacitor unit according to the analog touch signal to detect a touch event; and
a high impedance controller, coupled to the sensing capacitor unit, the control signal generation unit, and the detection unit, for conducting the analog touch signal to the detection unit according to the control signal.

12. The capacitive touch sensing apparatus of claim 11, wherein the sensing capacitor unit comprises an electrode.

13. The capacitive touch sensing apparatus of claim 12, wherein the electrode is made of Indium Tin Oxide material.

14. The capacitive touch sensing apparatus of claim 11, wherein the analog touch signals comprise an environmental capacitance and a variation amount of touch sensing capacitance.

15. The capacitive touch sensing apparatus of claim 14, wherein the detection unit determines the sensing capacitor unit undergoes a touch event when the sum of the environmental capacitance and the variation amount of touch sensing capacitance of the analog touch signal is greater than a threshold value.

16. The capacitive touch sensing apparatus of claim 14, wherein detection unit determines the sensing capacitor unit undergoes a touch event when the variation amount of touch sensing capacitance of the analog touch signal is greater than a threshold value.

17. A multi-touch detection method for a capacitive touch sensing apparatus, the capacitive touch sensing apparatus comprising a plurality of control signal lines, a plurality of signal transmission lines, a plurality of high impedance controllers, the plurality of control signal lines parallel with each other and disposed along a first direction, the plurality of signal transmission lines parallel with each other and disposed along a second direction different from the first direction, the plurality of high impedance controllers respectively disposed by intersections of the plurality of control signal lines and the plurality of signal transmission lines, the multi-touch detection method comprising:
generating a plurality of analog touch signals;
generating a plurality of control signals transmitted through the plurality of control signal lines;
conducting a corresponding analog touch signal to a corresponding signal transmission line according to a corresponding control signal by each of the corresponding high impedance controllers; and
determining whether sensing variation is occurring according to the conducted analog touch signal to detect a touch event.

18. The multi-touch detection method of claim 17, wherein the first direction is perpendicular to the second direction.

19. The multi-touch detection method of claim 17 further comprising:
controlling the plurality of control signals to take turns in the enable state to enable the corresponding high impedance controller coupled to the corresponding control signal line.

20. The multi-touch detection method of claim 19, wherein the step of controlling the plurality of control signals to take turns in the enable state to enable the corresponding high impedance controller coupled to the corresponding control signal line comprises controlling the plurality of control signals to be in the enable state along the first direction in turn to enable the corresponding high impedance controller coupled to the corresponding control signal line.

21. The multi-touch detection method of claim 17, wherein each of the analog touch signals comprises an environmental capacitance and a variation amount of touch sensing capacitance correspondingly.

22. The multi-touch detection method of claim 21, wherein the step of determining whether sensing variation occurs according to the conducted analog touch signal to detect the touch event comprises determining the touch event is detected when the sum of the environmental capacitance of the analog touch signal and the variation amount of touch sensing capacitance of the corresponding analog touch signal is greater than a threshold value.

23. The multi-touch detection method of claim 21, wherein the step of determining whether sensing variation occurs according to the conducted analog touch signal to detect the touch event comprises determining the touch event is detected when the variation amount of touch sensing capacitance of the corresponding analog touch signal is greater than a threshold value.

24. The multi-touch detection method of claim 17, wherein only one of the control signals is in an enable state at the same time.
